(19) United States
(12) Patent Application Publication
(10) Pub. No.: US 2026/0011499 A1
(43) Pub. Date: Jan. 8, 2026

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventor: Kana TAMURA, Tokyo (JP)

(73) Assignee: TAIYO YUDEN CO., LTD., Tokyo (JP)

(21) Appl. No.: 19/247,897

(22) Filed: Jun. 24, 2025

(30) Foreign Application Priority Data
Jul. 8, 2024 (JP) 2024-109837

(51) Int. Cl. H01G 4/232; H01G 4/008; H01G 4/12; H01G 4/224; H01G 4/248; H01G 4/30; H01G 13/00

(52) U.S. Cl. CPC H01G 4/2325; H01G 4/008; H01G 4/1227; H01G 4/224; H01G 4/248; H01G 4/30; H01G 13/003; H01G 13/006

(57) ABSTRACT

A multilayer ceramic electronic device includes an element body in which each of a plurality of internal electrodes and each of a plurality of dielectric layers mainly composed of ceramic are alternately stacked in a first direction, the element body having a pair of end faces to which the plurality of internal electrodes are alternately exposed, the pair of end faces facing each other in a second direction, copper sections being exposed from a surface of the element body, and a pair of external electrodes in contact with the plurality of internal electrodes exposed from the pair of end faces, respectively, and in contact with each of the copper sections, respectively.

### CROSS-REFERENCE TO RELATED APPLICATION

This application is based upon and claims the benefit of priority of the prior Japanese Patent Application No. 2024-109837, filed on Jul. 8, 2024, the entire contents of which are incorporated herein by reference.

### FIELD

A certain aspect of the present disclosure relates to a multilayer ceramic electronic device and a manufacturing method of the multilayer ceramic electronic device.

### BACKGROUND

It is known to add copper to a cover portion other than an active portion (for example, Japanese Patent Application Publication No. 2021-93549). It is also known to disperse ceramic powder as a co-material in a conductive paste that forms external electrodes (for example, Japanese Patent Application Publication No. H5-3134 or Japanese Patent Application Publication No. 2021-166214).

### SUMMARY OF THE INVENTION

According to an aspect of the embodiments, there is provided a multilayer ceramic electronic device including: an element body in which each of a plurality of internal electrodes and each of a plurality of dielectric layers mainly composed of ceramic are alternately stacked in a first direction, the element body having a pair of end faces to which the plurality of internal electrodes are alternately exposed, the pair of end faces facing each other in a second direction, copper sections being exposed from a surface of the element body; and a pair of external electrodes in contact with the plurality of internal electrodes exposed from the pair of end faces, respectively, and in contact with each of the copper sections, respectively.

According to another aspect of the embodiments, there is provided a manufacturing method of a multilayer ceramic electronic device, the method including: preparing an element body in which each of a plurality of internal electrodes and each of a plurality of dielectric layers mainly composed of ceramic are alternately stacked in a first direction, the element body having a pair of end faces to which the plurality of internal electrodes are alternately exposed, an outermost dielectric layer containing copper or a copper compound; firing the element body so that copper sections are exposed from a surface of the outermost dielectric layer; and forming a pair of external electrodes that contact the plurality of internal electrodes exposed from the pair of end faces, respectively, and that contact each of the copper sections, respectively.

According to another aspect of the embodiments, there is provided a manufacturing method of a multilayer ceramic electronic device, the method including: preparing an element body in which each of a plurality of internal electrodes and each of a plurality of dielectric layers mainly composed of ceramic are alternately stacked in a first direction, the element body having a pair of end faces to which the plurality of internal electrodes are alternately exposed, an outermost dielectric layer containing copper or a copper compound; firing the element body so that sections containing copper oxide is exposed from the surface of the outermost dielectric layer; forming copper sections from the sections containing copper oxide by reducing the sections containing copper oxide; and forming a pair of external electrodes that contact the plurality of internal electrodes exposed from the pair of end faces, respectively, and that contact each of the copper sections, respectively.

### BRIEF DESCRIPTION OF THE DRAWINGS

FIG. 1 is a partial cross-sectional perspective view of a multilayer ceramic capacitor according to a first embodiment;

FIG. 2 is a cross-sectional view taken along a line A-A in FIG. 1;

FIG. 3 is a cross-sectional view taken along a line B-B in FIG. 1;

FIG. 4 is a cross-sectional view taken along a line C-C in FIG. 1;

FIG. 5 is a flow chart of a method for manufacturing a multilayer ceramic capacitor according to a first embodiment;

FIG. 6A is a plan view of a method for manufacturing a multilayer ceramic capacitor according to a first embodiment;

FIG. 6B is a cross-sectional view taken along a line A-A in FIG. 6A;

FIG. 7 is a cross-sectional view of a method for manufacturing a multilayer ceramic capacitor according to a first embodiment;

FIG. 8A and FIG. 8B are cross-sectional views of a method for manufacturing a multilayer ceramic capacitor according to a first embodiment;

FIG. 9A and FIG. 9B are cross-sectional views of a method for measuring an occupancy rate and an average grain size of a coper section;

FIG. 10 is a cross-sectional view of a multilayer ceramic capacitor relating to a first modified embodiment;

FIG. 11 is a cross-sectional view of a multilayer ceramic capacitor relating to a second modified embodiment; and

FIG. 12 is a flowchart of a manufacturing method of a multilayer ceramic capacitor relating to a second modified embodiment.

### DETAILED DESCRIPTION

Although dispersing ceramic powder in ab external electrode improves adhesion between ab element body and the external electrode, stress is generated between the external electrode and the element body, which may cause cracks in the element body. There is a need to suppress the generation of stress between the external electrode and the element body while improving the adhesion between the element body and the external electrode.

Below, with reference to the drawings, an embodiment will be described using a multilayer ceramic capacitor as an example of a multilayer ceramic electronic device.

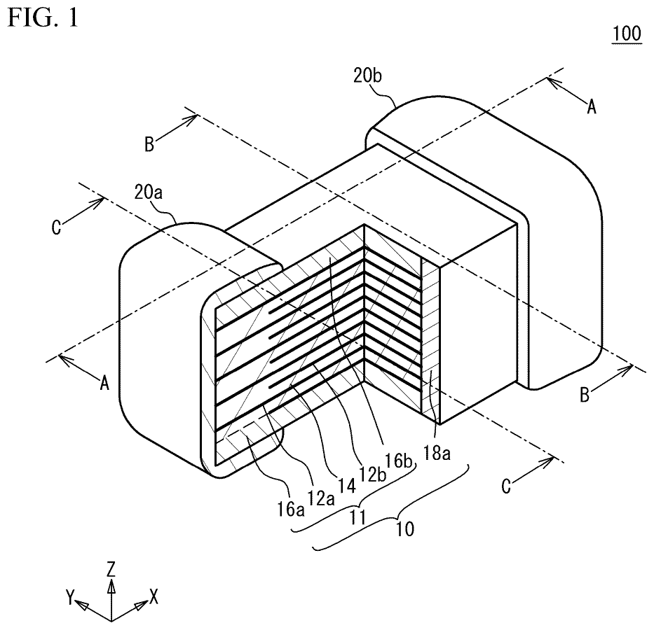

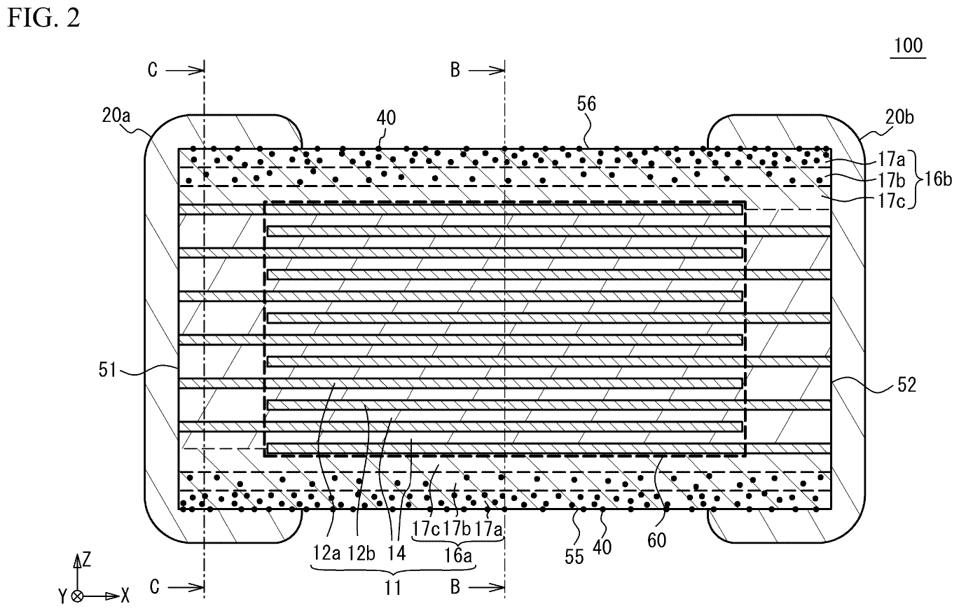

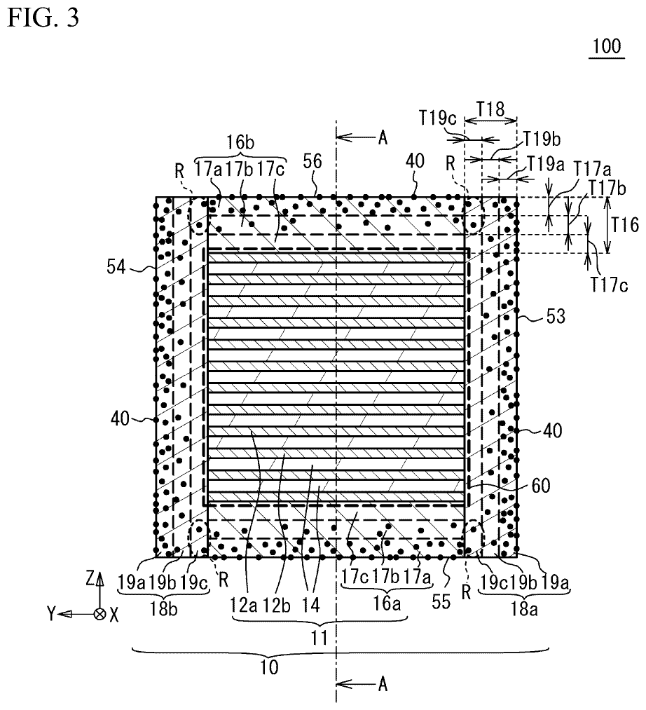

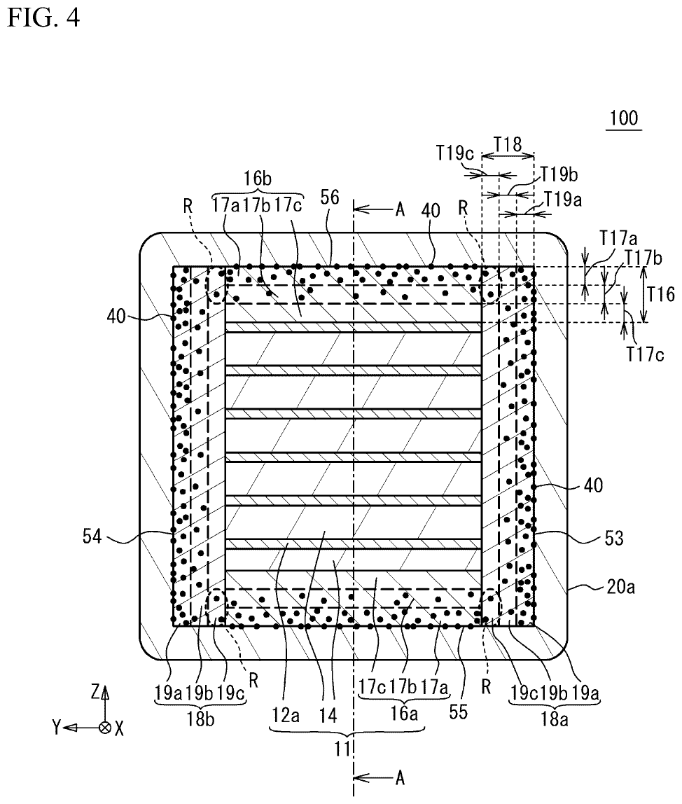

(Embodiment) FIG. 1 is a partial cross-sectional perspective view of a multilayer ceramic capacitor 100 according to a first embodiment. FIG. 2 is a cross-sectional view taken along a line A-A in FIG. 1. FIG. 3 is a cross-sectional view taken along a line B-B in FIG. 1. FIG. 4 is a cross-sectional view taken along a line C-C in FIG. 1. In FIG. 1 to FIG. 4, the Z direction (first direction) is the stacking direction in which dielectric layers 14 and the internal electrodes 12a and 12b are stacked, and is the direction in which a lower face 55 and an upper face 56 of an element body 10 face each other. The X direction (second direction) is the length direction of the element body 10, and is the direction in which a pair of end faces 51 and 52 of the element body 10 face each other. The Y direction (third direction) is the width direction of the internal electrodes 12a and 12b, and is the direction in which a pair of side faces 53 and 54 of the element body 10 face each other. The X-direction, the Y-direction, and the Z-direction intersect or are orthogonal to each other.

The multilayer ceramic capacitor 100 comprises the element body 10 having a substantially rectangular parallelepiped shape, and external electrodes 20a and 20b. The element body 10 comprises a multilayer body 11 and side dielectric layers 18a and 18b provided on both sides of the multilayer body 11 in the Y-direction.

The multilayer body 11 comprises the plurality of dielectric layers 14, the plurality of internal electrodes 12a and 12b, and cover dielectric layers 16a and 16b. The plurality of internal electrodes 12a and the plurality of internal electrodes 12b are alternately stacked. One of the plurality of dielectric layers 14 is provided between one of the plurality of internal electrodes 12a and one of the plurality of internal electrodes 12b. The bottom layer and the top layer of the multilayer body 11 are the cover dielectric layers 16a and 16b, respectively. The side dielectric layers 18a and 18b are provided on the surfaces of the multilayer body 11 in the Y-direction.

The internal electrodes 12a and 12b are alternately exposed at the end faces 51 and 52. The internal electrode 12a is exposed at the end face 51, but the internal electrode 12b is not exposed. The internal electrode 12b is exposed at the end face 52, but the internal electrode 12a is not exposed. In other words, the internal electrodes 12a and 12b are connected to the different end faces 51 and 52. The section of the element body 10 where the internal electrodes 12a and 12b overlap with each other across the dielectric layer 14 is a capacity section 60.

The cover dielectric layers 16a and 16b are provided with sections 17a, 17b, and 17c on the lower face 55 and the upper face 56, respectively. The side dielectric layers 18a and 18b are provided with sections 19a, 19b, and 19c on the side faces 53 and 54, respectively. A copper section 40 is provided within the sections 17a and 19a. The copper section 40 is a section in the element body 10 that contains copper as the main metal component. The copper section 40 diffuses copper atoms (hereinafter simply referred to as “copper”) into the surrounding dielectric section as described below. The diffused copper solid-dissolves in the dielectric layer.

The copper section 40 is exposed on the side faces 53, 54, the lower face 55, and the upper face 56. The occupancy rate of the copper section 40 in the sections 17b and 19b is smaller than that of the copper section 40 in the sections 17a and 19a. The occupancy rate of the copper section 40 in the sections 17c and 19c is smaller than that of the copper section 40 in the sections 17b and 19b. For example, the copper section 40 is almost absent in the sections 17c and 19c. Furthermore, the copper concentration in the dielectric layer in the sections 17b and 19b is lower than that in the sections 17a and 19a. The copper concentration in the sections 17c and 19c is lower than the copper concentration in the sections 17b and 19b. The sections 17a, 17b and 17c have thicknesses T17a, T17b and T17c, respectively, and the sections 19a, 19b and 19c have thicknesses T19a, T19b and T19c, respectively. The cover dielectric layers 16a and 16b have a thickness T16, and the side dielectric layers 18a and 18b have a thickness T18.

The external electrode 20a contacts the internal electrode 12a exposed from the element body 10 at the end face 51. The external electrode 20b contacts the internal electrode 12b exposed from the element body 10 at the end face 52. The external electrode 20a covers the ends in the −X direction of the side faces 53, 54, the lower face 55, and the upper face 56 in addition to the end face 51. The external electrode 20b contacts the internal electrode 12b at the end face 52. The external electrode 20b covers the ends in the +X direction of the side faces 53, 54, the lower face 55, and the upper face 56 in addition to the end face 52.

The size of the multilayer ceramic capacitor 100 is, for example, 0.25 mm in length (length in the X direction), 0.125 mm in width (width in the Y direction), and 0.125 mm in height (height in the Z direction), or 0.4 mm in length, 0.2 mm in width, and 0.2 mm in height, or 0.6 mm in length, 0.3 mm in width, and 0.3 mm in height, or 1.0 mm in length, 0.5 mm in width, and 0.5 mm in height, or 3.2 mm in length, 1.6 mm in width, and 1.6 mm in height, or 4.5 mm in length, 3.2 mm in width, and 2.5 mm in height. Note that the multilayer ceramic capacitor 100 is not limited to these sizes, but the effects described below are noticeable when the size is, for example, 1.0 mm or more in length, 0.5 mm or more in width, and 0.5 mm or more in height.

The internal electrodes 12a and 12b are mainly composed of base metals such as nickel (Ni), copper (Cu) and tin (Sn). Noble metals such as platinum (Pt), palladium (Pd), silver (Ag) and gold (Au) or alloys containing these may also be used as the internal electrodes 12a and 12b. The thickness of the internal electrodes 12a and 12b is, for example, 0.1 μm or more and 1 μm or less.

The dielectric layer 14 is mainly composed of a ceramic material having a perovskite structure represented by the general formula ABO₃. The perovskite structure includes ABO₃₋ₐ, which is not stoichiometric. For example, the ceramic material may be selected from at least one of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) that forms a perovskite structure. Ba_{1-x-y}CaₓSr_{y}Ti_{1-z}Zr_{z}O₃ is such as barium strontium titanate, barium calcium titanate, barium zirconate, barium titanate zirconate, calcium titanate zirconate, or barium calcium titanate zirconate. For example, the dielectric layer 14 contains 90 at % or more of the main component ceramic. The thickness of the dielectric layer 14 is, for example, 0.3 μm or more and 2 μm or less.

An additive may be added to the dielectric layer 14. An example of additives to the dielectric layer 14 is such as oxides of zirconium (Zr), hafnium (Hf), magnesium (Mg), manganese (Mn), molybdenum (Mo), vanadium (V), chromium (Cr), a rare earth element (yttrium (Y), samarium (Sm), europium (Eu), gadolinium (Gd), terbium (Tb), dysprosium (Dy), holmium (Ho), erbium (Er), thulium (Tm), or ytterbium (Yb)), or oxides containing cobalt (Co), nickel (Ni), lithium (Li), boron (B), sodium (Na), potassium (K), or silicon (Si), or glasses containing cobalt, nickel, lithium, boron, sodium, potassium, or silicon.

The composition of the main ceramic component of the cover dielectric layers 16a, 16b and the side dielectric layers 18a and 18b may be the same as or different from the main ceramic component of the dielectric layer 14. The thicknesses T16 and T18 of the cover dielectric layers 16a, 16b and the side dielectric layers 18a and 18b are, for example, 10 μm or more and 200 μm or less.

The external electrodes 20a and 20b are mainly composed of metals such as copper, nickel, aluminum (Al), and zinc (Zn), or alloys of two or more of these (for example, an alloy of copper and nickel), and contain ceramics such as glass components for densifying the external electrodes 20a and 20b and co-materials for controlling the sinterability of the external electrodes 20a and 20b. The glass components are oxides of barium (Ba), strontium (Sr), calcium (Ca), zinc, aluminum, silicon, boron, or the like. The co-material is, for example, a ceramic component whose main component is the same material as the main component of the dielectric layer 14. A plated film whose main component is, for example, a base metal such as nickel, copper, or tin may be formed on the surface of the external electrodes 20a and 20b. Furthermore, a film of a conductive resin such as an epoxy resin or a urethane resin may be formed on the surface of the plated film.

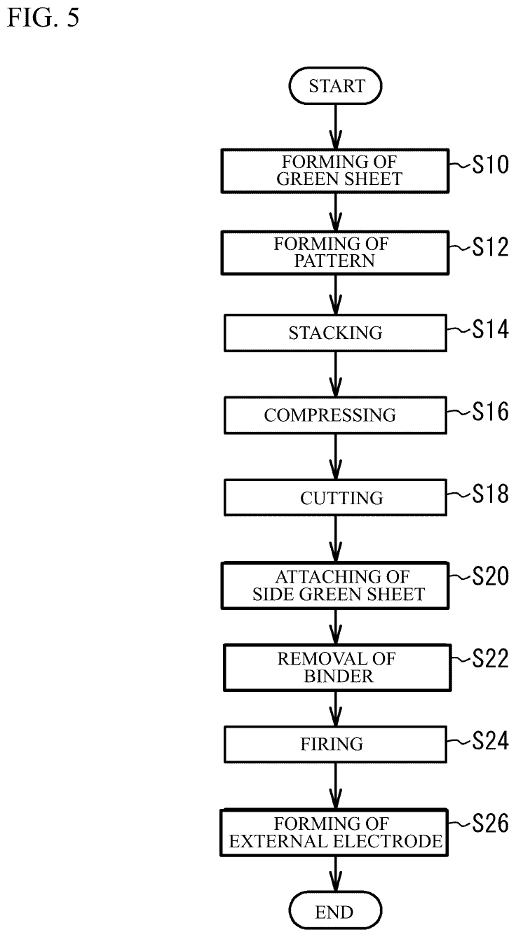

(Method of manufacturing a multilayer ceramic capacitor) The method of manufacturing the multilayer ceramic capacitor 100 will be described. FIG. 5 is a flowchart of the method of manufacturing the multilayer ceramic capacitor according to the first embodiment.

(Green Sheet Forming Step) First, green sheets 30a to 30c are formed (Step S10). In step S10, for example, various additive compounds (such as sintering aids) are added to ceramic powder to prepare a dielectric material. A binder such as polyvinyl butyral (PVB) resin, an organic solvent such as ethanol or toluene, and a plasticizer are added to the prepared dielectric material and wet-mixed to generate a slurry. The resulting slurry is used to coat the green sheets 30a to 30c on a base material, for example, by a die coater method or a doctor blade method. The base material is, for example, a PET (polyethylene terephthalate) film. The green sheets 30a to 30c are then dried.

Copper particles or particles of a copper compound are added to the dielectric material for the green sheets 30a and 30b. The copper compound is, for example, copper oxide (CuO or CuO₂). The copper concentration of the green sheet 30b is lower than that of the green sheet 30a. Copper or copper compounds are not added to the dielectric material for the green sheet 30c. When copper or copper compounds are added to the dielectric material for the green sheet 30c, the copper concentration of the green sheet 30c is lower than that of the green sheet 30b.

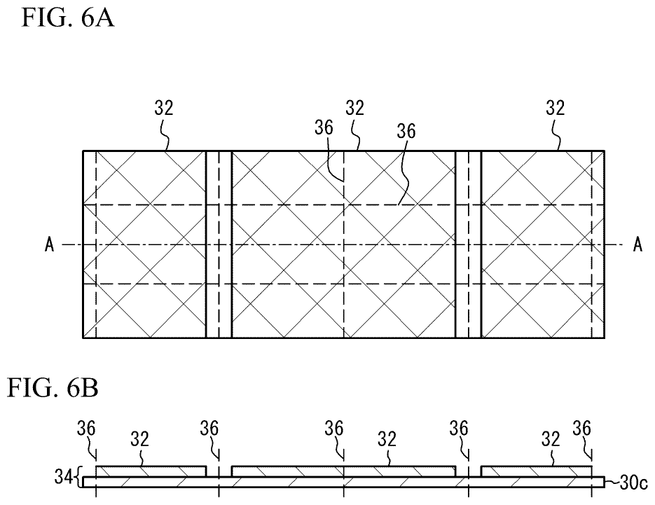

(Pattern Forming Step) Next, a metal pattern 32 is formed on the green sheet 30c (Step S12). FIG. 6A is a plan view of the manufacturing method of the multilayer ceramic capacitor according to the first embodiment, and FIG. 6B is a cross-sectional view taken along the line A-A in FIG. 6A. A cutting line 36 in FIG. 6A and FIG. 6B is the cutting line along which a stack sheet 35 is cut in Step S18.

In Step S12, first, a metal paste containing a metal powder, an organic binder, and an organic solvent is prepared. The metal paste may contain ceramic particles as a co-material. As illustrated in FIG. 6A and FIG. 6B, the metal paste is printed on the green sheet 30c using, for example, a gravure printing method to form the metal pattern 32. A dielectric pattern that is an inverse pattern of the metal pattern 32 may be formed between the metal patterns 32. In this manner, a stack sheet 34 in which the metal pattern 32 is formed on the green sheet 30c is formed.

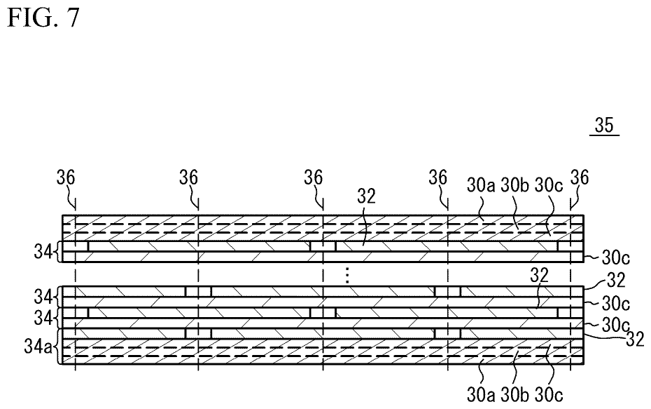

(Stacking Step) Next, the green sheets are stacked (Step S14). FIG. 7 is a cross-sectional view of the manufacturing method of the multilayer ceramic capacitor according to the first embodiment, and corresponds to the A-A cross section of FIG. 6A. In Step S14, the green sheet 30b is stacked on the green sheet 30a, and the green sheet 30c on which the metal pattern 32 is formed is stacked on the green sheet 30b to form a stack sheet 34a. The plurality of stack sheets 34 are stacked on the stack sheet 34a. The green sheets 30c, 30b, and 30a are stacked in this order on the top stack sheet 34. This forms the stack sheet 35 in which the plurality of stack sheets 34 are stacked. At this time, the metal patterns 32 are provided alternately.

(Compressing Step) Next, the stack sheet 35 is compressed (Step S16). In Step S16, the stack sheet 35 formed in Step S14 is pressed to bond the stack sheets 34a and 34 together. For example, a hydrostatic press is used as a compressing means.

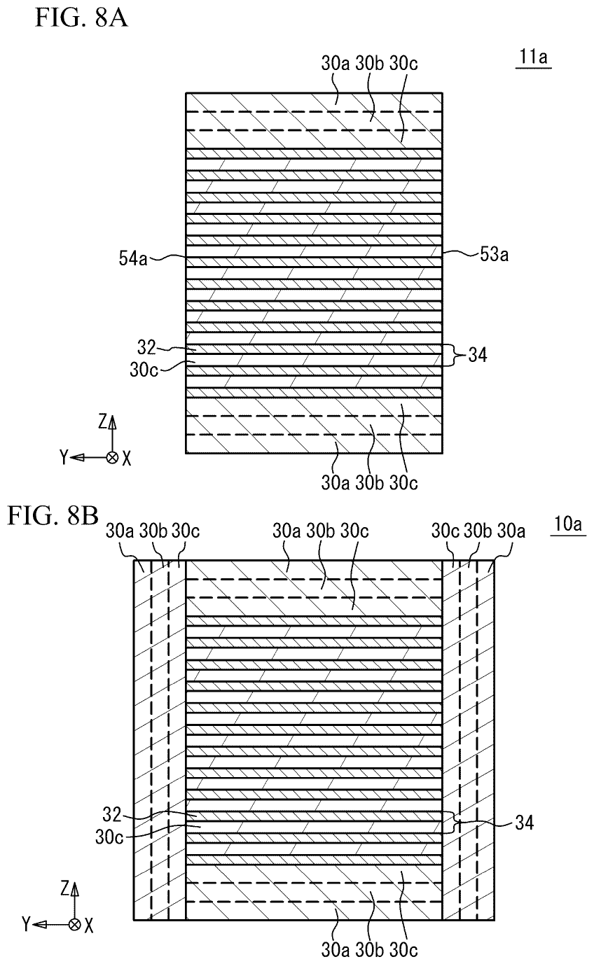

(Cutting Step) Then, the stack sheet 35 is cut (Step S18). In Step S18, the stack sheet 35 is cut in the stacking direction along the predetermined cutting line 36 with a cutting blade to prepare a plurality of multilayer bodies 11a. FIG. 8A and FIG. 8B are cross-sectional views of the method for manufacturing a multilayer ceramic capacitor according to the first embodiment, and correspond to the cross section of line B-B in FIG. 1 to FIG. 4. As illustrated in FIG. 8A and FIG. 8B, in the multilayer body 11a, the metal pattern 32 is exposed from side faces 53a and 54a.

(Side Green Sheet Attaching Step) Next, the side green sheets are attached (Step S20). In Step S20, as illustrated in FIG. 8B, the side face 53a of the multilayer body 11a is pressed against the green sheets 30c to 30a for the side dielectric layer 18a in sequence, thereby attaching the green sheets 30c to 30a to the side face 53a. Similarly, the green sheets 30c to 30a are attached to the side face 54a of the multilayer body 11a. After Step S20, an element body 10a may be polished by a method such as barrel polishing. This rounds the corners of the element body 10a.

(Binder Removal Step) Next, the element body 10a is fired (Step S22). In Step S22, the element body 10a is subjected to a binder removal step in an air atmosphere at 300° C. to 700° C. At this time, the carbon in the organic material such as the binder is oxidized, so that the oxygen concentration is reduced. Therefore, the atmosphere is weakly reducing. Therefore, even if copper oxide powder is contained in the green sheets 30b and 30c, the copper oxide is reduced to become a metallic copper section. At this time, some of the copper in the copper oxide powder diffuses into the green sheets 30b and 30c.

(Firing Step) Subsequently, the element body 10a is fired (Step S24). In Step S24, the element body 10a is fired in a reducing atmosphere (for example, an atmosphere in which hydrogen gas is mixed with air) at 1100° C. to 1300° C. As a result, each particle in the element body 10a is sintered to form the element body 10. By increasing the temperature rise rate in the firing step, the oxidation of the copper section 40 can be suppressed. For example, the temperature rise rate is set to 10,000° C./h to 20,000° C./h. Although the surface of the copper section 40 is somewhat oxidized, the inside of the copper section 40 remains copper in a state close to metal. As a result, the cover dielectric layers 16a, 16b and the side dielectric layers 18a and 18b are formed from the green sheets 30a to 30c. The internal electrodes 12a and 12b are formed from the metal pattern 32. The dielectric layer 14 is formed from the green sheet 30c located between the internal electrodes 12a and 12b.

(External Electrode Forming Step) Subsequently, the external electrodes 20a, 20b are formed (Step S26). In Step S26, a conductive paste containing, for example, metal powder, glass frit, binder, and solvent is applied to the end faces 51, 52 of the element body 10. After the conductive paste is applied, the conductive paste is baked to form the base metal layer of the external electrodes 20a, 20b. The binder and the solvent evaporate by baking. The conductive paste is applied, for example, by a dipping method. A plated layer may be formed on the base metal layer.

During the firing step or the external electrode forming step, diffusion of the copper particles or copper compound particles added to the green sheets 30a, 30b occurs between the side dielectric layers 18a, 18b and the cover dielectric layers 16a, 16b. For example, referring to FIG. 3 and FIG. 4, the section 19c of the side dielectric layers 18a, 18b is formed from the green sheet 30c that does not contain copper particles or copper compound particles. Meanwhile, the sections 19a and 19b of the side dielectric layers 18a and 18b and the sections 17a and 17b of the cover dielectric layers 16a and 16b are formed from the green sheets 30a and 30b that contain those particles.

Therefore, at an end R of the section 19c in the Z direction between the sections 19a and 19b and the sections 17a and 17b, copper particles or copper compound particles diffuse from the sections 19a and 19b and the sections 17a and 17b to form the copper section 40. As a result, when the cross section of the element body 10 along the Y direction and the Z direction is viewed from the front, many copper sections 40 are provided in the square-shaped sections 19a, 19b, 19c, 17a and 17b on the surface side of the element body 10 so as to surround the capacity section 60.

In the first embodiment, as illustrated in FUG. 2 to FIG. 4, the copper section 40 is exposed from the outermost dielectric layer (for example, the sections 17a and 19a) including the surface of the element body 10. The surface of the copper section 40 has a higher surface free energy than the surface of the dielectric. Therefore, the surface of the copper section 40 has better wettability with the conductive paste when forming the external electrodes 20a and 20b than the surface of the dielectric. This improves the adhesion between the external electrodes 20a and 20b and the element body 10. In particular, when the sections of the external electrodes 20a and 20b in contact with the element body 10 are mainly composed of copper, the adhesion between the external electrodes 20a and 20b and the element body 10 is improved.

After the external electrodes 20a and 20b are baked (Step S26), copper is likely to diffuse from the copper section 40 exposed on the surface of the element body 10 into the external electrodes 20a and 20b. At this time, if the main component metal element of the base metal layer of the external electrodes 20a and 20b in contact with the element body surface is an element other than copper (for example, Ni), an alloy (Ni—Cu alloy) will be formed with the copper diffused from the copper section 40.

On the other hand, when the main metallic element of the base metal layer of the external electrodes 20a and 20b is copper, an alloy is not formed by copper diffusion, but the portion of the copper section 40 exposed from the surface of the element body 10 that is outside the surface is integrated with the base metal layer. This exposed copper section 40 can be confirmed by detecting the copper section 40 that contacts the boundary between the external electrodes 20a and 20b and the element body 10 in, for example, images of a cut surface of the multilayer ceramic capacitor 100 as illustrated in FIG. 2 and FIG. 4. Here, contacting the boundary means, for example, that the section of the base metal layer and the copper section 40 are continuous without being interrupted by the dielectric component of the element body 10. Note that confirmation means include, for example, a SEM (Scanning Electron Microscope), but are not limited to this.

From the viewpoint of improving the adhesion between the external electrodes 20a and 20b and the element body 10, the oxygen concentration at the center of the copper section 40 present in a cross section at a depth of 10 μm from the surface of the element body 10 is preferably 30 atomic % or less, more preferably 25 atomic % or less, and even more preferably 20 atomic % or less. The copper concentration in the copper section 40 on the surface of the element body 10 where the external electrodes 20a and 20b contact is preferably 50 atomic % or more, and more preferably 70 atomic % or more.

Here, the cross section at a depth of 10 μm from the surface of the element body 10 refers to, for example, the upper face 56 and the lower face 55 facing the stacking direction in which the dielectric layers 14 and the internal electrodes 12a and 12b are stacked, and the inner peripheral surface 10 μm inward from each of the side faces 53 and 54 facing the stacking direction and the length direction in which the end faces 51 and 52 face. Note that the depth position 10 μm from the surface of the element body 10 does not necessarily have to be a distance of 10 μm from the surface in the strict sense, but may be a cross section at a distance within a range of 5 μm to 15 μm from the surface of the element body 10.

The oxygen concentration at the center of the copper section 40 is measured by spot measurement using SEM (Scanning Electron Microscope)-EDS (Energy Dispersive X-ray Spectroscopy). Note that the center of the copper section 40 does not have to be the exact center, and it is sufficient that the spot does not include the interface between the copper section 40 and the dielectric. In the copper section 40, the main component metal element of the dielectric layer may be diffused. Therefore, the oxygen concentration of the copper section 40 is determined by subtracting the oxygen in the oxide of the main component metal element of the dielectric layer from the measured copper concentration. For example, when the dielectric layer is barium titanate, the main component metal elements are Ba and Ti. The oxides of Ba and Ti are mainly BaO and TiO₂. If the O concentration, Ba concentration, and Ti concentration detected by SEM-EDX are CO, CBa, and CTi, respectively, the oxygen concentration in the copper section 40 can be calculated by CO−(CBa+CTi×2).

From the viewpoint of improving the adhesion between the external electrodes 20a and 20b, the occupancy rate of the copper section 40 in the cross section at a depth of 10 μm from the surface of the element body 10 is preferably 0.05% or more, more preferably 0.09% or more, and even more preferably 0.2% or more. When the occupancy rate of the copper section 40 becomes high, the diffusion of copper into the dielectric layer increases, and the dielectric layer becomes too dense. This makes the element body 10 more susceptible to cracks. From this viewpoint, the occupancy rate of the copper section 40 at a depth of 10 μm from the surface of the element body 10 is preferably 5.5% or less, more preferably 5% or less, even more preferably 4% or less, and even more preferably 3% or less.

From the viewpoint of improving the adhesion between the external electrodes 20a and 20b, the average grain size of the copper section 40 present in the cross section at a depth position of 10 μm from the surface of the element body 10 is preferably 100 nm or more, more preferably 120 nm or more, and even more preferably 150 nm or more. From the viewpoint of preventing excessive densification, the average grain size of the copper section 40 on the surface of the element body 10 where the external electrodes 20a and 20b contact is preferably 3200 nm or less, more preferably 3000 nm or less, and even more preferably 2000 nm or less.

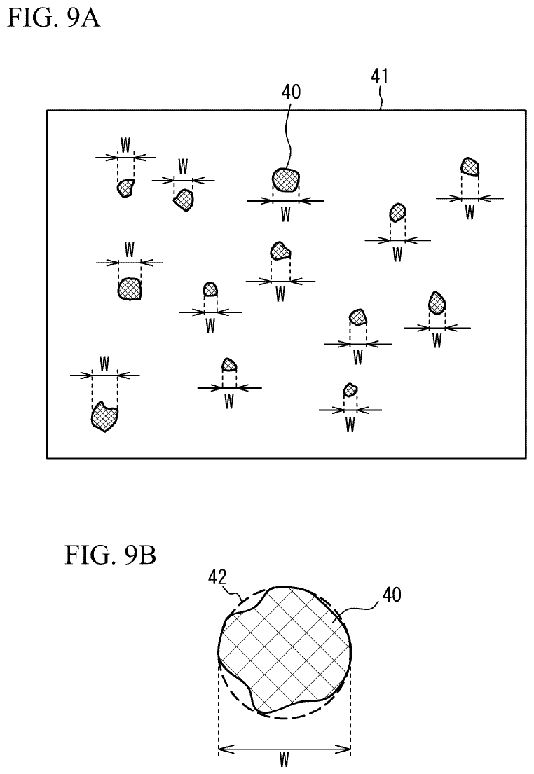

FIG. 9A and FIG. 9B are cross-sectional views of a method for measuring the occupancy rate and average grain size of the copper sections 40. FIG. 9A is a schematic diagram of an electron microscope image (for example, SEM image) of a cross section obtained by mirror-polishing the element body 10 to a thickness of 10 μm from the surface. The magnification of the electron microscope is, for example, 10,000 times. With this magnification, for example, an area of 140 μm×105 μm in size in the cross section can be observed. In this area, as illustrated in FIG. 9A, the copper sections 40 can be observed in an electron microscope image 41. The maximum width of each of the copper sections 40 in a certain direction (horizontal direction in FIG. 9A) is set to the width W of the copper section 40. As illustrated in FIG. 9B, a circle 42 with the width W as its diameter is assumed. The total area of the circles 42 of the copper sections 40 in the image 41 is divided by the area of the image 41, and the result is multiplied by 100 to obtain the occupancy rate (%). Moreover, the average value of the widths W of the copper sections 40 in the image 41 is taken as the average grain size of the copper sections 40. When the number of copper sections 40 in the image 41 is less than 10 or is 100 or more, the occupancy rate and the average grain size may be measured by changing the magnification of the image 41. This average grain size is calculated, for example, as the average of all the copper sections 40 that can be confirmed in the section of the above size.

When copper atoms diffuse from the copper section 40 into the dielectric in the sections 17a and 19a, the copper concentration near the surface of the element body 10 (the copper concentration in the dielectric not including the copper section 40) becomes high. In this case, the sections 17a and 19a become denser. This reduces the number of open pores on the surfaces of the sections 17a and 19a. This makes it possible to suppress the diffusion of moisture into the inside of the element body 10.

However, if the copper concentration of the dielectric layer 14 in the capacity section 60 is high, the electrical characteristics of the capacitor deteriorate. Furthermore, if the copper of the dielectric layer 14 diffuses into the internal electrodes 12a and 12b, the characteristics of the internal electrodes 12a and 12b deteriorate. For example, if the main component of the internal electrodes 12a and 12b is nickel, the internal electrodes 12a and 12b are more likely to deteriorate if copper diffuses into the internal electrodes 12a and 12b. Therefore, the copper concentration in the sections 17a and 19a in contact with the copper section 40 present in the cross section at a depth of 10 μm from the surface of the element body 10 is made higher than the copper concentration in the dielectric layer 14 in the capacity section 60. This suppresses deterioration of the electrical characteristics of the capacitor and densifies the portion near the surface of the element body 10.

The copper concentration in the dielectric in the sections 17a and 19a in contact with the copper section 40 present in the cross section at a depth of 10 μm from the surface of the element body 10 is preferably 0.1 atomic % or more, more preferably 0.2 atomic % or more, and even more preferably 0.3 atomic % or more. The copper concentration in the sections 17a and 19a is preferably 2.0 atomic % or less, more preferably 1.8 atomic % or less, and even more preferably 1.5 atomic % or less. The copper concentration in the dielectric in the sections 17a and 19a in contact with the copper section 40 is measured, for example, by spot measurement using SEM-EDS, by applying the spot to the dielectric so as not to include the interface between the copper section 40 and the dielectric.

The copper concentration in the dielectric in the sections 17a and 19a is preferably 10 times or more, more preferably 100 times or more, of the copper concentration in the dielectric in the dielectric layer 14 in the capacity section 60. It is preferable that no copper is added to the dielectric layer 14 in the capacity section 60. Note that no copper is added to the dielectric layer 14 means that no copper is intentionally added to the dielectric layer 14.

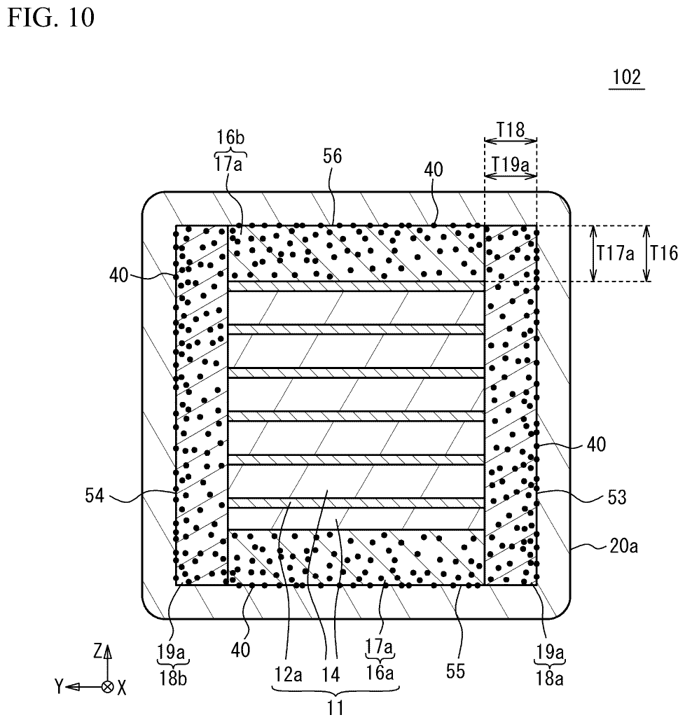

(First Modified Embodiment) FIG. 10 is a cross-sectional view of a multilayer ceramic capacitor according to a first modified embodiment. As illustrated in FIG. 10, in a multilayer ceramic capacitor 102 of the first modified embodiment, the cover dielectric layers 16a and 16b are entirely the section 17a, and the occupancy rate of the copper section 40 is high. The side dielectric layers 18a and 18b are entirely the section 19a, with a high occupancy rate of the copper section 40. The other configurations are the same as those in the first embodiment, and therefore description thereof will be omitted.

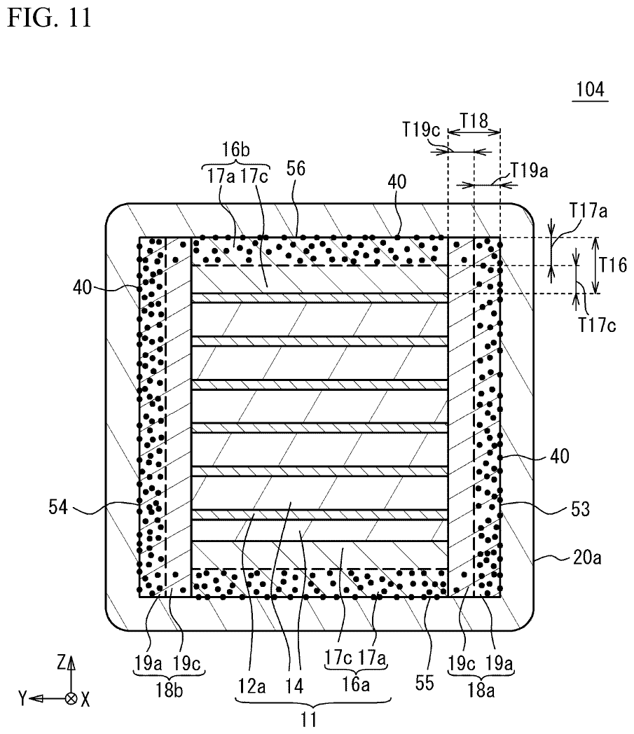

(Second Modified embodiment) FIG. 11 is a cross-sectional view of a multilayer ceramic capacitor according to a second modified embodiment. As illustrated in FIG. 11, in a multilayer ceramic capacitor 104 according to the second modified embodiment, the cover dielectric layers 16a and 16b have the sections 17a and 17c, but do not have the section 17b. The side dielectric layers 18a and 18b have the sections 19a and 19c, but do not have the section 19b. The other configurations are the same as those of the first embodiment, and the description is omitted.

As in the first modified embodiment, the cover dielectric layers 16a and 16b may entirely be the section 17a, and the side dielectric layers 18a and 18b may entirely be the section 19a. That is, the cover dielectric layers 16a and 16b and the side dielectric layers 18a and 18b may include the copper section 40 in all sections. However, if the section in contact with the capacity section 60 contains copper, there is a possibility that the copper will diffuse into the internal electrodes 12a and 12b. This may result in deterioration of the electrical characteristics of the capacitor.

Therefore, as in the first embodiment and the second modified embodiment, the copper concentration in the sections 17a and 19a in contact with the surfaces of the cover dielectric layers 16a and 16b and the side dielectric layers 18a and 18b is higher than the copper concentration in the sections 17c and 19c in contact with the capacity section 60 of the cover dielectric layers 16a and 16b and the side dielectric layers 18a and 18b. This makes it possible to suppress the diffusion of copper into the capacity section 60.

The copper concentration in the sections 17a and 19a is preferably 5 times or more, and more preferably 10 times or more, the occupancy rate of the copper section 40 in the sections 17c and 19c. It is preferable that no copper is added to the sections 17c and 19c. It is also preferable that the copper section 40 is not included in the sections 17c and 19c.

From the viewpoint of preventing copper from diffusing into the capacity section 60, the thickness T17c of the section 17c is preferably 0.02 times or more, more preferably 0.05 times or more, and even more preferably 0.1 times or more, the thickness T16 of the cover dielectric layers 16a and 16b. The thickness T19c of the section 19c is preferably 0.02 times or more, more preferably 0.05 times or more, and even more preferably 0.1 times or more, the thickness T18 of the side dielectric layers 18a and 18b. If the sections 17c and 19c are thick, the sections 17a and 19a become thin, and it becomes difficult to generate the copper section 40. In addition, the section to be densified becomes thin, and moisture and the like become more likely to diffuse into the capacity section 60. From this viewpoint, the thickness T17c is preferably 0.6 times or less, more preferably 0.5 times or less, and even more preferably 0.4 times or less, the thickness T16. The thickness T19c is preferably 0.6 times or less, more preferably 0.5 times or less, and even more preferably 0.4 times or less, the thickness T18.

By increasing the thicknesses T17a and T19a, the copper section 40 is generated, improving the adhesion between the external electrodes 20a and 20b and the element body 10. Also, the sections 17a and 19a are densified, and the sections 17c and 19c, which are prone to the diffusion of moisture or the like are thinned. This makes it possible to suppress the diffusion of moisture or the like into the capacity section 60. From this viewpoint, the thicknesses T17a and T19a are preferably 0.2 times or more, more preferably 0.3 times or more, and even more preferably 0.4 times or more, of the thicknesses T16 and T18, respectively. If the thicknesses T17a and T19a are large, the diffusion of copper into the capacity section 60 will be large, and the electrical characteristics of the capacitor will deteriorate. From this viewpoint, the thicknesses T17a and T19a are preferably 0.8 times or less, more preferably 0.7 times or less, and even more preferably 0.6 times or less, of the thicknesses T16 and T18, respectively.

As in first embodiment, the section 17b is provided between the sections 17a and 17c, and the section 19b is provided between the sections 19a and 19c. The copper concentration in the section 17b is lower than the copper concentration in the section 17a and higher than the copper concentration in the section 17c. The copper concentration in the section 19b is lower than the copper concentration in the section 19a and higher than the copper concentration in the section 19c. In the first modified embodiment and the second modified embodiment, when the sections 17a and 19a become densified, the sections 17a and 19a shrink. This increases the stress applied to the capacity section 60 and the sections 17c and 19c, which may cause cracks or the like to occur in the element body 10. Therefore, by providing the sections 17b and 19b, the stress can be alleviated.

From the viewpoint of stress relaxation, the thickness T17b of the section 17b is preferably 0.05 times or more, more preferably 0.1 times or more, and even more preferably 0.2 times or more, the thickness T16 of the cover dielectric layers 16a and 16b. The thickness T19b of the section 19b is preferably 0.05 times or more, more preferably 0.1 times or more, and even more preferably 0.2 times or more, the thickness T18 of the side dielectric layers 18a and 18b. If the sections 17b and 19b become too thick, the functions of the sections 17a, 17c, 19a and 19c will be impaired. From this viewpoint, the thickness T17b is preferably 0.6 times or less, more preferably 0.4 times or less, and even more preferably 0.2 times or less, the thickness T16. The thickness T19b is preferably 0.6 times or less, more preferably 0.4 times or less, and even more preferably 0.2 times or less, the thickness T18.

An example has been described in which the sections 17a and 19a are provided on the side faces 53 and 54, the lower face 55, and the upper face 56, but the sections 17a and 19a may be provided on at least one of the side faces 53, 54, the lower face 55, and the upper face 56. The sections 17a and 19a may be provided on at least a portion of the side faces 53, 54, the lower face 55, and the upper face 56 in which the external electrodes 20a and 20b are provided, and may not be provided in areas in which the external electrodes 20a and 20b are not provided.

As in the following example, when the cover dielectric layers 16a and 16b and the side dielectric layers 18a and 18b are mainly composed of barium titanate, the internal electrodes 12a and 12b are mainly composed of nickel, and the portions of the external electrodes 20a and 20b in contact with the element body 10 are mainly composed of copper, the effects of the first embodiment can be particularly achieved.

Note that a certain element is the main component of a certain member means that the certain element is contained in the certain member to an extent that the effect of the embodiment is achieved, and the concentration of the certain element in the certain member is, for example, 50 mol % or more, 80 mol % or more, or 90 mol % or more.

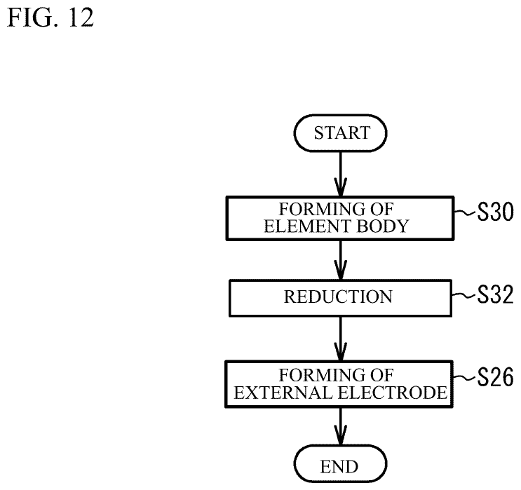

(Second embodiment) FIG. 12 is a flow chart of a method for manufacturing a multilayer ceramic capacitor according to the second embodiment. As illustrated in FIG. 12, first, the element body 10 is formed (Step S30). Step S30 is the same as steps S10 to S24 in FIG. 5. At this time, in the firing step, copper may be oxidized to form a section containing copper oxide. Next, the element body 10 is reduced (Step S32). In the reduction step of Step S32, the element body 10 is heat-treated, for example, in an air atmosphere with a high concentration of hydrogen gas. As a result, the section containing copper oxide is reduced, and the copper section 40 close to metal is formed. Next, the external electrodes 20a and 20b are formed on the element body 10 (Step S26).

As in Step S30 of the second embodiment, the element body 10 is fired so that the section containing copper oxide is exposed from the surface of the outermost dielectric layer. Thereafter, as in Step S32, the section containing copper oxide is reduced to form the copper section 40 from the section containing copper oxide. In this manner, a multilayer ceramic capacitor containing the copper section 40 similar to that of the multilayer ceramic capacitor of the first embodiment can be manufactured.

### EXAMPLE

The multilayer ceramic capacitors of Examples and Comparative Examples were manufactured according to the flow illustrated in FIG. 5. In the green sheet forming step Step S10 of FIG. 5, Cu powder, CuO powder or CuO₂ powder with an average particle size of 30 nm to 4000 nm, BaTiO₂ powder with an average particle size of 100 nm, various additives such as rare earth oxides, and organic solvents were mixed and crushed using zirconia beads with a diameter of 1 mm. A binder was then added and the mixture was applied onto the base material. The green sheets 30a and 30b were mixed with the desired amount of Cu powder, CuO powder, or CuO₂ powder, and the green sheet 30c was mixed with no Cu powder, CuO powder, or CuO₂ powder.

Steps S12 to S20 in FIG. 5 were performed. The binder removal step S22 was performed in an air atmosphere, and the firing step S24 was performed in an air atmosphere containing hydrogen gas. The heating rates during firing were 500° C./h, 1000° C./h, and 15000° /h. The fabricated multilayer ceramic capacitor had T17a and T19a of about 60 μm, T17b and T19b of about 30 μm, and T17c and T19c of about 10 μm. The fabricated sample had a length of 1.0 mm, a width of 0.5 mm, and a height of 0.5 mm.

Tables 1 and 2 show the preparation conditions and measurement results for Examples and Comparative Examples.

TABLE 1

| | | | | AVERAGE | O |
|---|---|---|---|---|---|
| | ΔT/t | Cu AMOUNT | | GRAIN SIZE | CONCENTRATION |
| | [° C./h] | [atomic %] | ADDITIVE | [nm] | [atomic %] |
| COPARATIVE EXAMPLE 1 | 15000 | 0 | — | — | 0 |
| EXAMPLE 1 | 15000 | 28 | CuO | 3000 | 20 |
| EXAMPLE 2 | 15000 | 25 | CuO | 1200 | 19 |
| EXAMPLE 3 | 15000 | 20 | CuO | 370 | 18 |
| EXAMPLE 4 | 15000 | 10 | CuO | 320 | 19 |
| EXAMPLE 5 | 15000 | 5 | CuO | 190 | 18 |
| EXAMPLE 6 | 15000 | 4 | CuO | 190 | 17 |
| EXAMPLE 7 | 15000 | 3 | CuO | 190 | 17 |
| EXAMPLE 8 | 15000 | 2 | CuO | 180 | 15 |
| EXAMPLE 9 | 15000 | 1 | CuO | 120 | 10 |
| EXAMPLE 10 | 15000 | 0.5 | CuO | 100 | 18 |
| EXAMPLE 11 | 15000 | 30 | CuO | 3000 | 25 |
| EXAMPLE 12 | 15000 | 32 | CuO | 3000 | 30 |
| EXAMPLE 13 | 15000 | 5 | Cu | 190 | 18 |
| EXAMPLE 14 | 15000 | 5 | CuO₂ | 190 | 17 |
| EXAMPLE 15 | 15000 | 33 | CuO | 3200 | 20 |
| COPARATIVE EXAMPLE 2 | 500 | 5 | Cu | 100 | 31 |
| COPARATIVE EXAMPLE 3 | 500 | 5 | CuO | 100 | 35 |
| COPARATIVE EXAMPLE 4 | 500 | 10 | CuO | 10 | 37 |
| COPARATIVE EXAMPLE 5 | 1000 | 10 | CuO | 15 | 35 |
| COPARATIVE EXAMPLE 6 | 15000 | 5 | In₂O₃ | 230 | 60 |
| COPARATIVE EXAMPLE 7 | 15000 | 5 | ZnO | 220 | 50 |
| COPARATIVE EXAMPLE 8 | 15000 | 5 | MgO | 140 | 54 |

TABLE 2

| | Cu | OCCUPANCY | NUMBER | NUMBER | |
|---|---|---|---|---|---|
| | DIFFUSION | RATE | OF SHORT | OF | |
| | [atomic %] | [%] | CIRCUITS | PEELINGS | GRADE |
| COPARATIVE EXAMPLE 1 | 0 | 0 | 40 | 10 | D |
| EXAMPLE 1 | 1.5 | 3.00 | 0 | 0 | A |
| EXAMPLE 2 | 1.3 | 2.60 | 0 | 0 | A |
| EXAMPLE 3 | 1.0 | 2.30 | 0 | 0 | A |
| EXAMPLE 4 | 0.6 | 1.10 | 0 | 0 | A |
| EXAMPLE 5 | 0.5 | 0.64 | 0 | 0 | A |
| EXAMPLE 6 | 0.4 | 0.52 | 0 | 0 | A |
| EXAMPLE 7 | 0.4 | 0.35 | 0 | 0 | A |
| EXAMPLE 8 | 0.2 | 0.23 | 0 | 0 | A |
| EXAMPLE 9 | 0.2 | 0.09 | 0 | 0 | A |
| EXAMPLE 10 | 0.1 | 0.05 | 10 | 2 | B |
| EXAMPLE 11 | 1.6 | 3.50 | 10 | 0 | B |
| EXAMPLE 12 | 1.8 | 5.0 | 15 | 0 | B |
| EXAMPLE 13 | 0.5 | 0.63 | 0 | 0 | A |
| EXAMPLE 14 | 0.6 | 0.62 | 0 | 0 | A |
| EXAMPLE 15 | 2.0 | 5.50 | 40 | 0 | C |
| COPARATIVE EXAMPLE 2 | 3.0 | 0.40 | 50 | 10 | D |
| COPARATIVE EXAMPLE 3 | 3.1 | 0.32 | 50 | 10 | D |
| COPARATIVE EXAMPLE 4 | 3.5 | 0.60 | 50 | 10 | D |
| COPARATIVE EXAMPLE 5 | 3.7 | 0.71 | 50 | 10 | D |
| COPARATIVE EXAMPLE 6 | 3.0 | 0.58 | 30 | 10 | D |
| COPARATIVE EXAMPLE 7 | 3.1 | 0.43 | 20 | 10 | D |
| COPARATIVE EXAMPLE 8 | 3.3 | 0.34 | 20 | 10 | D |

In Tables 1 and 2, “ΔT/t” is the heating rate in the firing step S24. “Cu amount” is the amount of copper in the Cu, CuO or CuO₂ powder in the green sheet 30a in Step S10 expressed relative to barium (Ba) and titanium (Ti). In Comparative Examples 7 to 9, the amounts of indium (In), zinc (Zn) and magnesium (Mg) expressed relative to barium and titanium are shown. “Additive” is a material added to the green sheets 30a and 30b in Step S10.

“Average grain size” is the average grain size of the copper section 40 after the firing step, calculated from an SEM image of the cross section at a depth of 10 μm from the surface. “O concentration” is the amount of oxygen (O) concentration in the copper section 40 measured by SEM-EDS measurement of the cross section at a depth of 10 μm from the surface. The measurement conditions were an acceleration voltage of 20 kV, an electron beam spot diameter of 50 mm, and a magnification of 20,000 times, and the O concentration at the center of the copper section 40 was measured. As described above, the O concentration was corrected for the O concentration due to BaO and TiO₂. “Cu diffusion” is the amount of copper concentration in BaTiO₃ near the copper section 40 measured by SEM-EDS measurement of a cross section at a depth of 10 μm from the surface. In Comparative Examples 6, 7, and 8, “Cu diffusion” is the indium concentration, zinc concentration, and magnesium concentration, respectively. The measurement method is the same as the measurement of “O concentration”. “Occupancy rate” is the occupation rate of the copper section 40 after the firing step, and was calculated from an SEM image of a cross section at a depth of 10 μm from the surface.

“Number of short circuits” is the result of a moisture resistance load test. The 50 samples were held for a predetermined time in an environment with a temperature of 80° C. and a humidity of 90% to 95% RH with a rated voltage applied between the external electrodes 20a and 20b. The number of samples that subsequently developed short circuits was recorded as the “number of short circuits.” The “number of peelings” is an evaluation of the adhesion between the external electrodes 20a and 20b and the element body 10. The external electrodes 20a and 20b of the samples thus produced were mounted on a substrate with a length of 100 mm, a width of 40 mm, and a thickness of 1.6 mm using solder. The substrate was then bent with the center of the substrate as a fulcrum and a point ±45 mm from the fulcrum in the length direction as a force point. At this time, it was checked whether peeling occurred at the interface between the external electrodes 20a and 20b and the element body 10. The number of samples out of the 10 samples that developed peeling was recorded as the “number of peelings”.

When both the “number of short circuits” and the “number of peelings” were 0, the grade “A” was given. When the “number of short circuits” was 15 or less and the “number of peelings” was 2 or less, the grade “B” was given. When the “number of short circuits” was 20 or more and the “number of peelings” was 0, the grade “C” was given. Anything other than the above was given the grade of “D.” The grade A indicates that both moisture resistance and adhesion are good. The grade “B” indicates that both moisture resistance and adhesion are good, but not as good as the grade “A”. The grade “C” indicates that moisture resistance is poor, but adhesion is as good as the grade “A”. The grade “D” indicates that both moisture resistance and adhesion are poor.

(Comparative Example 1) When no copper was added to the green sheets 30a to 30c as in Comparative Example 1, the copper section 40 was not formed, and the grade was “D,” which was poor.

(Comparative Examples 2 to 5) As in Comparative Examples 2 to 5, even if Cu or CuO powder was added to the green sheets 30a and 30b, if the heating rate was slow, the oxygen concentration in the section where copper existed was 30 atomic % or more, and Cu diffusion was 3 atomic % or more. In this case, the grade is “D” and it is poor. This is because if the heating rate in the firing step is slow, copper will be oxidized in the copper section. This reduces the adhesion between the external electrodes 20a and 20b and the element body 10. In addition, the diffusion of copper into BaTiO₃ is large, and the BaTiO₃ becomes too dense, causing cracks in the element body 10 and degrading its moisture resistance.

(Comparative Examples 6 to 8) When metal elements other than copper (indium, zinc, or magnesium) were added to the green sheets 30a and 30b as in Comparative Examples 6 to 8, the O concentration in the metal element section was 50 atomic % or more, and the diffusion of the metal element into BaTiO₃ was 3 atomic % or more, even if ΔT/t was 15000° C./h, as in Examples 1 to 15. The grade is “D”. This is thought to be because even if indium, zinc, or magnesium is reduced in the binder removal step, indium, zinc, or magnesium is easily oxidized in the firing step and is not easily turned into a metal. On the other hand, copper is less easily oxidized than nickel. Therefore, if the firing step conditions are set to a level that does not oxidize the nickel of the internal electrodes 12a and 12b, the oxidation of the copper reduced in the binder removal step in the firing step can be suppressed.

(Examples 1 to 15) In Examples 1 to 15, the Cu amount was 0.5 atomic % or more and 33 atomic % or less, the average grain size was 100 nm or more and 3200 nm or less, the O concentration was 10 atomic % or more and 30 atomic % or less, the Cu diffusion was 0.1 atomic % or more and 2.0 atomic % or less, and the occupancy was 0.05% or more and 5.5% or less. In the above ranges, the grade is A, B, or C, and the moisture resistance and adhesion can be improved compared to Comparative Examples 1 to 8.

(Examples 5, 13, and 14) In Examples 5, 13, and 14, which have the same Cu amount, Examples 13 and 14, which use Cu or CuO₂ as the additive, have almost the same average grain size, O concentration, Cu diffusion, and occupancy as Example 5, which uses CuO as the additive, and are also evaluated as grade “A”. Thus, the copper added to the green sheets 30a and 30b may be any of Cu, CuO, and CuO₂.

(Examples 1 to 9) In Examples 1 to 9, the Cu amount was 1 atomic % or more and 28 atomic % or less, the average grain size was 120 nm or more and 3000 nm or less, the O concentration was 10 atomic % or more and 20 atomic % or less, the Cu diffusion was 0.2 atomic % or more and 1.5 atomic % or less, and the occupancy rate was 0.09 atomic % or more and 3.00 atomic % or less. Within the above ranges, the grade is “A”.

(Examples 10 to 12) On the other hand, in Examples 10 to 12, the Cu amount was 0.5 atomic % or less or 30 atomic % or more, the average grain size was 100 nm or 3000 nm, the O concentration was 18 atomic % or more, the Cu diffusion was 0.1 atomic % or more or 1.6 atomic % or more, and the occupancy rate was 0.05 atomic % or more or 3.5 atomic % or more. In this case, the grade is “B”. The moisture resistance and adhesion are improved from Comparative Examples 1to 8, but are worse than Examples 1 to 9.

TABLE 3

| | Cu | Cu | |
|---|---|---|---|
| | RESIDUAL | DIFFUSION | |
| | RATE | RATE | |
| | [%] | [%] | GRADE |
| COPARATIVE EXAMPLE 1 | — | — | D |
| EXAMPLE 1 | 95 | 5 | A |
| EXAMPLE 2 | 95 | 5 | A |
| EXAMPLE 3 | 95 | 5 | A |
| EXAMPLE 4 | 94 | 6 | A |
| EXAMPLE 5 | 90 | 10 | A |
| EXAMPLE 6 | 90 | 10 | A |
| EXAMPLE 7 | 87 | 13 | A |
| EXAMPLE 8 | 90 | 10 | A |
| EXAMPLE 9 | 80 | 20 | A |
| EXAMPLE 10 | 80 | 20 | B |
| EXAMPLE 11 | 95 | 5 | B |
| EXAMPLE 12 | 94 | 6 | B |
| EXAMPLE 13 | 90 | 10 | A |
| EXAMPLE 14 | 88 | 12 | A |
| EXAMPLE 15 | 94 | 6 | C |
| COPARATIVE EXAMPLE 2 | 40 | 60 | D |
| COPARATIVE EXAMPLE 3 | 38 | 62 | D |
| COPARATIVE EXAMPLE 4 | 65 | 35 | D |
| COPARATIVE EXAMPLE 5 | 63 | 37 | D |
| COPARATIVE EXAMPLE 6 | — | — | D |
| COPARATIVE EXAMPLE 7 | — | — | D |
| COPARATIVE EXAMPLE 8 | — | — | D |

Table 3 shows the “Cu residual rate”, “Cu diffusion rate”, and “Grade” for Examples 1 to 15 and Comparative Examples 2 to 5, which have the copper section 40. The “Cu residual rate” is the ratio (%) of copper that remains without diffusing from the copper section 40, and the “Cu diffusion rate” is the ratio (%) of copper that diffuses from the copper section 40. The “Cu residual rate” is calculated by (“Cu amount”−“Cu diffusion”)÷“Cu amount”×100. The “Cu diffusion rate” is calculated by “Cu diffusion”÷“Cu amount”×100. The “Grade” is the same as the “Grade” in Table 2.

In the range where the “Cu residual rate” is 80 to 95%, in other words the “Cu diffusion rate” is 5 to 20%, the grade is “A”, “B”, or “C”. In contrast, in the range where the “Cu residual rate” is 38 to 65%, in other words the “Cu diffusion rate” is 35 to 62%, the grade is “D”. Therefore, the moisture resistance and adhesion are better when “Cu residual rate”>“Cu diffusion rate” is satisfied than when “Cu residual rate”<“Cu diffusion rate” is satisfied.

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
an element body in which each of a plurality of internal electrodes and each of a plurality of dielectric layers mainly composed of ceramic are alternately stacked in a first direction, the element body having a pair of end faces to which the plurality of internal electrodes are alternately exposed, the pair of end faces facing each other in a second direction, copper sections being exposed from a surface of the element body; and
a pair of external electrodes in contact with the plurality of internal electrodes exposed from the pair of end faces, respectively, and in contact with each of the copper sections, respectively.

2. The multilayer ceramic electronic device as claimed in claim 1,
wherein an oxygen concentration at a center of the copper section in a cross section at a depth of 10 μm from the surface of the element body is 30 atomic % or less.

3. The multilayer ceramic electronic device as claimed in claim 1,
wherein an occupancy rate of the copper section present in the cross section at a depth position of 10 μm from the surface of the element body is 0.05% or more and 5.50% or less.

4. The multilayer ceramic electronic device as claimed in claim 1,
wherein an average grain size of the copper section is 100 nm or more and 3200 nm or less.

5. The multilayer ceramic electronic device as claimed in claim 1,
Wherein a copper concentration in a dielectric in a section in contact with the copper section in the cross section at a depth position of 10 μm from the surface of the element body is higher than the copper concentration in a dielectric of the plurality of dielectric layers in a capacity section where the plurality of internal electrodes overlap.

6. The multilayer ceramic electronic device as claimed in claim 1,
wherein the plurality of dielectric layers in a capacity section where the plurality of internal electrodes overlap each other do not contain copper.

7. The multilayer ceramic electronic device as claimed in claim 1,
wherein the element body comprises:
a cover dielectric layer that is an outermost in the first direction; and
side dielectric layers that are arranged to sandwich a capacity section where plurality of the internal electrodes overlap in a third direction that intersects with the first direction and the second direction, and
wherein the copper section is exposed through at least one of the cover dielectric layer and the side dielectric layers.

8. The multilayer ceramic electronic device as claimed in claim 7,
wherein the cover dielectric layer and the side dielectric layers are not provided with a copper section, in a portion adjacent to the capacity section.

9. The multilayer ceramic electronic device as claimed in claim 1,
wherein the plurality of dielectric layers are mainly made of barium titanate,
wherein the plurality of internal electrodes are mainly made of nickel, and
wherein a portion of the pair of external electrodes that contacts the element body is mainly made of copper.

10. A manufacturing method of a multilayer ceramic electronic device, the method comprising:
preparing an element body in which each of a plurality of internal electrodes and each of a plurality of dielectric layers mainly composed of ceramic are alternately stacked in a first direction, the element body having a pair of end faces to which the plurality of internal electrodes are alternately exposed, an outermost dielectric layer containing copper or a copper compound;
firing the element body so that copper sections are exposed from a surface of the outermost dielectric layer; and
forming a pair of external electrodes that contact the plurality of internal electrodes exposed from the pair of end faces, respectively, and that contact each of the copper sections, respectively.

11. A manufacturing method of a multilayer ceramic electronic device, the method comprising:
preparing an element body in which each of a plurality of internal electrodes and each of a plurality of dielectric layers mainly composed of ceramic are alternately stacked in a first direction, the element body having a pair of end faces to which the plurality of internal electrodes are alternately exposed, an outermost dielectric layer containing copper or a copper compound;
firing the element body so that sections containing copper oxide is exposed from the surface of the outermost dielectric layer;
forming copper sections from the sections containing copper oxide by reducing the sections containing copper oxide; and
forming a pair of external electrodes that contact the plurality of internal electrodes exposed from the pair of end faces, respectively, and that contact each of the copper sections, respectively.
